(19) United States
(12) Patent Application Publication
(10) Pub. No.: US 2020/0087218 A1
(43) Pub. Date: Mar. 19, 2020

(54) COMPOSITE CONCRETE MATERIAL AND METHOD OF MAKING A COMPOSITE CONCRETE MATERIAL

(71) Applicant: Oldcastle Precast, Inc., Auburn, WA (US)

(72) Inventors: John Ronald Gogol, Portland, OR (US); Charles Leblanc, Longueuil (CA)

(21) Appl. No.: 16/569,929

(22) Filed: Sep. 13, 2019

Related U.S. Application Data
(60) Provisional application No. 62/730,989, filed on Sep. 13, 2018.

(51) Int. Cl. C04B 41/52; C04B 41/00; C04B 41/45; C04B 14/42; C04B 24/24

(52) U.S. Cl. CPC C04B 41/528; C04B 41/0072; C04B 24/24; C04B 14/42; C04B 41/4505

(57) ABSTRACT

A lightweight composite concrete cover is provided for subgrade trenches and vaults. The lightweight cover comprises at least one low density layer that has a low density filler material such as polyethylene terephthalate beads. The low density layer substantially reduces the overall weight of the cover, and the remaining layers provide sufficient structure for the cover to pass rigorous load and chemical exposure testing. In addition, a method of manufacturing a lightweight cover is provided that promotes the combination of different layers of the cover and the cross linking of polymer chains between layers of the cover. The lightweight cover has substantial weight savings and also meets rigorous testing standards such that a worker can manually remove the cover, transportation costs are realized, and worker safety is improved.

### CROSS-REFERENCE TO RELATED APPLICATIONS

This application claims priority under 35 U.S.C. § 119(e) to U.S. Provisional Patent Application Ser. No. 62/730,989 filed Sep. 13, 2018, which is incorporated herein in its entirety by reference.

### FIELD

The present disclosure relates generally to a composite concrete material that includes a low density concrete mix and methods of making the composite concrete material for use as a trench cover, a vault cover, etc.

### BACKGROUND

Subgrade utility trenches and utility vaults are widely used to both enclose and provide access to utilities such as electrical cables for street lighting, fiber optic cables for telephone and communication systems, and water valves for residential communities and golf courses. Trenches are structures that can be positioned in the ground with their upper surfaces even with the ground. In addition, trenches are often positioned in streets, sidewalks, and other thoroughfares where loads from pedestrians and vehicles are anticipated. Environmental factors such as precipitation and exposure to harmful chemicals are also anticipated. Therefore, trenches typically need to meet testing standards that include load testing and chemical exposure testing.

Trench enclosures often comprise a cover that encloses the trench and serves as the top surface of the trench, and the cover can be removed to provide access to utilities for maintenance. Trench enclosures or boxes are made from durable materials such as concrete to meet testing standards, and similarly, trench covers are also made from durable materials. While these materials help meet testing standards, these materials are substantially heavy which makes the trench enclosures and cover costly to ship and install. Some covers weigh so much as to require a hoist or other mechanical means to remove the cover from the trench, and this hampers the usefulness of the cover and presents a hazard to workers removing the cover.

Lighter composite materials are generally known, but manufacturing a composite material to meet the rigorous testing standards of trenches and vaults is difficult. For instance, the simple presence of air between layers of a composite material during the manufacturing process can degrade the ability of the composite material to withstand load forces and chemical exposure. As a result, manufacturers typically use durable but heavy materials that meet rigorous testing standards. Therefore, there is a long felt but unmet need for a trench or utility enclosure cover with a substantially reduced weight to allow for the manually removal of the cover from a trench, reduce transportation costs, and improve worker safety, but also meet rigorous testing standards.

### SUMMARY

It is an object of the present disclosure to provide a lightweight cover for a utility trench or utility vault that meets testing standards for load forces and chemical exposure and to provide a method of manufacturing the lightweight cover. The cover can be a composite material that includes a low density layer with a low density filler material that substantially reduces the overall weight of the cover. In addition, the process for manufacturing the lightweight cover produces a cover that is strong enough to meet testing standards.

It is an aspect of embodiments of the present disclosure to provide a composite concrete cover for a trench or vault where the cover has multiple layers including a low density layer to reduce the weight of the cover. The cover can comprise a low density layer made from a mix of materials such as a thermoset resin, a catalyst, and aggregates that comprise a low density filler material. The low density layer occupies a volume of the cover, but weighs less than other layers. The cover also comprises concrete layers that have a thermoset resin and a reinforcing fiber or structure such as fiberglass, metal rebar, etc. When manufactured, at least some of the polymer chains from the stronger concrete layers cross link with at least some of the polymer chains of the low density layer to create a finished cover. When the low density layer is positioned between two concrete layers in the composite cover, the cover retains the necessary strength to pass rigorous testing standards, but also has a substantial reduction in weight.

It is a further aspect of embodiments of the present disclosure to provide a composite concrete cover with a low density layer made from a mix that has a low density filler material to reduce the weight of the cover. In one embodiment, the low density filler material is a polyethylene terephthalate (PET) bead. These beads can have a diameter between approximately 1-20 mm and a density of less than approximately 400 kg/m³, which is typically at least half of the density of the thermoset resin. In addition to these beads, many other materials that are compatible with, for instance, a thermoset resin are contemplated as low density filler materials. As a result, the use of the low density filler material consumes volume and dramatically reduces the density of the cover.

It is another aspect of embodiments of the present disclosure to provide a method of manufacturing a composite concrete cover with a low density layer where the finished cover passes rigorous testing standards. In one embodiment, a form and press are used to combine the various layers of the composite concrete cover. The form can be heated to a predetermined temperature to promote curing of, for example, a thermoset resin in the various layers. The layers are positioned in the form, and the low density mix that forms the low density layer is poured between two concrete layers. The form can have a motor that vibrates to remove air from the layers and from the interfaces between layers to improve the bonding between layers. A press imposes a force and pressure on the layers that promotes curing and the cross linking of polymer chains between layers. After a predetermined time, the press releases the layers and the cover is ejected or removed from the form. The resulting cover with combined layers is sufficient to pass rigorous testing standards.

It is a further aspect of embodiments of the present disclosure to provide a composite concrete cover with an aperture to accommodate a locking system. Covers can lock relative to trench enclosures or utility vaults to prevent theft of utilities stored in the trench or vault and to protect the utilities from traffic loads and harmful chemicals. An aperture in a composite concrete cover can provide access for a locking mechanism to secure the cover to a trench enclosure or utility vault. Examples of locking systems can be found in U.S. Pat. Nos. 8,835,757; 9,174,798; 9,919,853; 9,932,157; D841279; 9,435,099; 10,240,316, which are incorporated herein in their entireties by reference.

One specific embodiment of the present disclosure is a method of manufacturing a low density composite concrete material, comprising (i) mixing a thermoset resin, a catalyst, and at least one aggregate to form a polymer concrete mix, wherein the at least one aggregate has a filler material with a density less than 400 kg/m3; (ii) heating a form to at least 200° F., wherein the form has a predetermined shape and defines a volume; (iii) positioning a first polymer concrete layer in the form; (iv) pouring the polymer concrete mix on the first polymer concrete layer; (v) positioning a second polymer concrete layer on the polymer concrete mix; (vi) vibrating the form to remove at least some air at a first interface between the first polymer concrete layer and the polymer concrete mix and at a second interface between the polymer concrete mix and the second polymer concrete layer; and (vii) pressing the first polymer concrete layer, the polymer concrete mix, and the second polymer concrete layer into the form with at least 80 psi of pressure to form a composite concrete material.

In some embodiments, the method further comprises (viii) driving a cylinder into the volume defined by the form to release the composite concrete material from the form. In various embodiments, the first polymer concrete layer, the polymer concrete mix, and the second polymer concrete layer are pressed for at least six minutes before driving the cylinder into the volume defined by the form. In some embodiments, the polymer concrete mix has a lower density than the first polymer concrete layer, and the polymer mix weighs more than the first polymer concrete layer. In various embodiments, at least one electric heater heats the form to between approximately 250-350° F. In some embodiments, wherein the composite concrete material is at least one of a vault cover, a trench enclosure, or a utility vault.

Another particular embodiment of the present disclosure is a composite concrete cover, comprising a first concrete layer that has a first polymer and a plurality of reinforcing fibers; a second concrete layer that has a second polymer and the plurality of reinforcing fibers; a low density layer positioned between the first concrete layer and the second concrete layer, wherein the low density layer has a third polymer and has a filler material with a density of less than 400 kg/m3, and wherein the low density layer is less than 40% of a weight of the composite concrete cover and greater than 40% of a volume of the composite concrete cover; a first interface between the first concrete layer and the low density layer, wherein at least one polymer chain of the first polymer and at least one polymer chain of the third polymer are cross linked together; and a second interface between the second concrete layer and the low density layer, wherein at least one polymer chain of the second polymer and at least one polymer chain of the third polymer are cross linked together.

In various embodiments, the cover further comprises a reinforcement layer embedded in the first concrete layer, wherein the reinforcement layer has higher tensile strength and ductility than the first concrete layer. In some embodiments, the first polymer is a thermoset polymer, and the plurality of reinforcing fibers of the first concrete layer are fiberglass. In various embodiments, the third polymer is a thermoset polymer, and the low density layer comprises an organic oxide, silica sand, and silica flour. In some embodiments, the cover further comprises at least one aperture extending through the first concrete layer, the low density layer, and the second concrete layer. In various embodiments, the cover further comprises a top layer positioned on the second concrete layer, wherein the top layer is at least partially formed of a fourth polymer; and a third interface between the top layer and the second concrete layer, wherein at least one polymer chain of the second polymer and at least one polymer chain of the fourth polymer are cross linked together. In some embodiments, the top layer has a plurality of protrusions extending from an outer surface of the top layer to improve traction.

Yet another particular embodiment of the present disclosure is a method of manufacturing a low density composite concrete cover, comprising (ix) mixing a polymer and at least one aggregate to form a polymer concrete mix, wherein the at least one aggregate has a filler material with a density less than 400 kg/m3; (x) heating a form to at least 200° F., wherein the form has a predetermined shape and defines a volume; (xi) positioning a first concrete layer in the form, the first concrete layer having a first polymer and reinforcement fibers; (xii) pouring the polymer concrete mix on the first concrete layer, wherein a first interface is defined between the first concrete layer and the polymer concrete mix; (xiii) positioning a second concrete layer on the polymer concrete mix, the second concrete layer having a second polymer and reinforcement fibers, wherein a second interface is defined between the second concrete layer and the polymer concrete mix; and (xiv) pressing the first concrete layer, the polymer concrete mix, and the second concrete layer into the form with at least 80 psi of pressure for at least 6 minutes, wherein at least one polymer chain of the polymer concrete mix and the first polymer are cross linked at the first interface, and wherein at least one polymer chain of the polymer concrete mix and the second polymer are cross linked at the second interface.

In some embodiments, the method further comprises (xv) vibrating the form to remove at least some air at the first interface and at the second interface. In various embodiments, vibrating the form begins as the polymer concrete mix is poured onto the first concrete layer and stops as the first concrete layer, the polymer concrete layer, and the second concrete layer are pressed together. In some embodiments, the method further comprises (xvi) embedding a reinforcement layer in the second concrete layer, wherein the reinforcement layer has a higher tensile strength and ductility than the second concrete layer. In some embodiments, the filler material is one of a plurality of polyethylene terephthalate foam beads or a plurality of expanded glass beads. In various embodiments, the first concrete layer, the polymer concrete mix, and the second concrete layer are pressed into the form for between approximately 7-10 minutes. In some embodiments, a hydraulic press presses the first concrete layer, the polymer concrete mix, and the second concrete layer into the form with a pressure between approximately 80 and 150 psi.

This Summary is neither intended nor should it be construed as being representative of the full extent and scope of the present disclosure. The present disclosure is set forth in various levels of detail in the Summary as well as in the attached drawings and the Detailed Description and no limitation as to the scope of the present disclosure is intended by either the inclusion or non-inclusion of elements or components. Additional aspects of the present disclosure will become more readily apparent from the Detailed Description, particularly when taken together with the drawings.

The above-described embodiments, objectives, and configurations are neither complete nor exhaustive. As will be appreciated, other embodiments of the disclosure are possible using, alone or in combination, one or more of the features set forth above or described in detail below.

The phrases “at least one,” “one or more,” and “and/or,” as used herein, are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” means A alone, B alone, C alone, A and B together, A and C together, B and C together, or A, B, and C together.

Unless otherwise indicated, all numbers expressing quantities, dimensions, conditions, and so forth used in the specification and claims are to be understood as being modified in all instances by the term “about.”

The term “a” or “an” entity, as used herein, refers to one or more of that entity. As such, the terms “a” (or “an”), “one or more,” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein.

It shall be understood that the term “means” as used herein shall be given its broadest possible interpretation in accordance with 35 U.S.C. § 112(f). Accordingly, a claim incorporating the term “means” shall cover all structures, materials, or acts set forth herein, and all of the equivalents thereof. Further, the structures, materials, or acts and the equivalents thereof shall include all those described in the Summary, Brief Description of the Drawings, Detailed Description, Abstract, and claims themselves.

### BRIEF DESCRIPTION OF THE DRAWINGS

The accompanying drawings, which are incorporated in and constitute a part of the specification, illustrate embodiments of the disclosure and together with the Summary given above and the Detailed Description of the drawings given below, serve to explain the principles of these embodiments. In certain instances, details that are not necessary for an understanding of the disclosure or that render other details difficult to perceive may have been omitted. It should be understood, of course, that the disclosure is not necessarily limited to the particular embodiments illustrated herein. Additionally, it should be understood that the drawings are not necessarily to scale.

FIG. 1 is an exploded, perspective view of a cover according to one embodiment of the present disclosure;

FIG. 2A is a top plan view of the cover in FIG. 1 according to one embodiment of the present disclosure;

FIG. 2B is a cross-sectional elevation view of the cover in FIG. 2A taken along line B-B according to one embodiment of the present disclosure;

FIG. 2C is a bottom plan view of the cover in FIG. 2A according to one embodiment of the present disclosure;

FIG. 3A is an exploded, perspective view of another cover according to one embodiment of the present disclosure;

FIG. 3B is a side elevation view of the cover in FIG. 3A according to one embodiment of the present disclosure;

FIG. 4A is a perspective view of layers of a cover in a form during manufacturing according to one embodiment of the present disclosure;

FIG. 4B is a perspective view of layers of the cover in the form of FIG. 4A during manufacturing with a press moving downwardly according to one embodiment of the present disclosure;

FIG. 4C is a perspective view of the cover ejected from the form in FIG. 4B according to one embodiment of the present disclosure; and

FIG. 5 is a method of manufacturing a composite concrete cover according to one embodiment of the present disclosure.

The following is a list of components depicted in the attached figures.

| Component No. | Component |
|---|---|
| 10 | Composite Concrete Cover |
| 12 | First Layer |
| 14 | Reinforcement Layer |
| 16 | Low Density Layer |
| 18 | Second Layer |
| 20 | Surface Layer |
| 22 | Aperture |
| 24 | Additional Layer |
| 26 | Form |
| 28 | Volume |
| 30 | Heater |
| 32 | Motor |
| 34 | Press |
| 36 | Cylinder |
| 38 | Method of Manufacture |
| 40 | Heating Form |
| 42 | Placing Layer |
| 44 | Pouring Mix |
| 46 | Leveling and Vibrating Mix |
| 48 | Placing Layer |
| 50 | Closing Press |
| 52 | Stop Vibrating Mix |
| 54 | Opening Press |
| 56 | Ejecting Cover |

Similar components and/or features may have the same reference label. Further, various components of the same type may be distinguished by following the reference label by a letter that distinguishes among the similar components. If only the first reference label is used, the description is applicable to any one of the similar components having the same first reference label irrespective of the second reference label.

### DETAILED DESCRIPTION

The present disclosure has significant benefits across a broad spectrum of endeavors. It is the Applicant's intent that this specification and the claims appended hereto be accorded a breadth in keeping with the scope and spirit of the disclosure being disclosed despite what might appear to be limiting language imposed by the requirements of referring to the specific examples disclosed. To acquaint persons skilled in the pertinent arts most closely related to the present disclosure, a preferred embodiment that illustrates the best mode now contemplated for putting the disclosure into practice is described herein by, and with reference to, the annexed drawings that form a part of the specification. The exemplary embodiment is described in detail without attempting to describe all of the various forms and modifications in which the disclosure might be embodied. As such, the embodiments described herein are illustrative, and as will become apparent to those skilled in the arts, may be modified in numerous ways within the scope and spirit of the disclosure.

Although the following text sets forth a detailed description of numerous different embodiments, it should be understood that the detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims. To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning.

Various embodiments of the present disclosure are described herein and as depicted in the drawings. It is expressly understood that although the figures depict a trench cover the present disclosure is not limited to this embodiment. Further, some terms may be used interchangeably, for example, “lid” and “cover” may be used interchangeably.

### Composite Cover

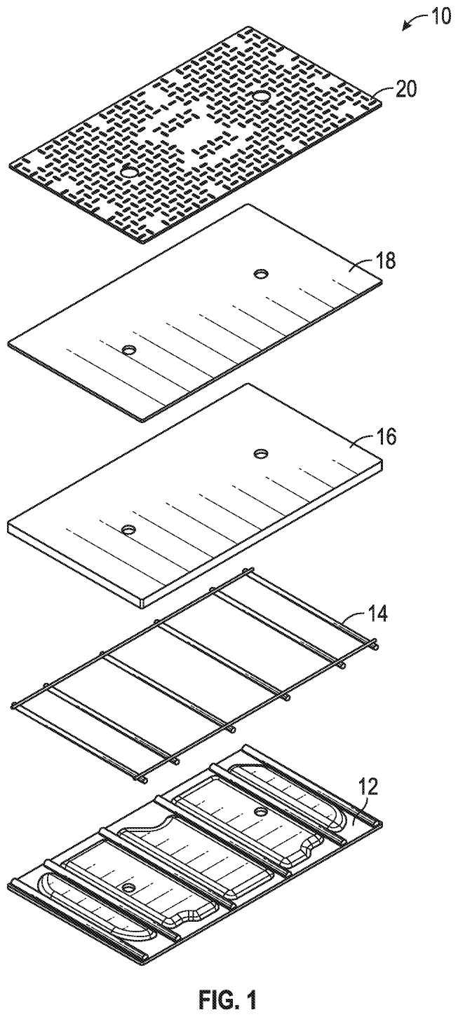

Now referring to FIG. 1, an exploded, perspective view of a composite concrete cover 10 is provided. As shown, the cover 10 comprises several layers 12, 14, 16, 18, 20. A fiberglass sheet molding concrete (SMC) layer 12 is the bottom layer of the cover 10 that at least partially defines the interior of the trench or vault. The first SMC layer 12 is a concrete layer that has a resin as a binder and fiberglass as a reinforcement. In one embodiment, the resin is a thermoset resin which is a polymer that is irreversibly hardened by curing from a soft solid or viscous liquid prepolymer or resin. The fiberglass may be, for example, chopped fiberglass or a pre-impregnated fibrous material with long fibers, and the fibers can be fiberglass, carbon fiber, or other reinforcing fibers.

The first SMC layer 12 can be produced by dispersing fiber strands in a bath of soft thermoset resin. The strands may be greater than one inch in length, and the thermoset resin may be polyester resin, vinyl ester resin, epoxy resin, etc. An SMC layer allows for a higher production volume, better reproducibility, and lower cost. Further, the first SMC layer 12 may be provided in rolls or in sheets such as mats, cloth, and tape.

Next, a reinforcement layer 14 can be positioned above or incorporated into the first SMC layer 12. The reinforcement layer 14 may extend to the edges of the cover 10 in some embodiments. Moreover, the reinforcement layer 14 can comprise metal rebar, carbon fiber, fiber glass, vinyl ester resin, fiberglass reinforced polymer, etc. to add strength to the cover 10. More specifically, the reinforcement layer 14 has higher tensile strength and ductility than the first SMC layer 12.

A low density layer 16 is positioned above the first SMC layer 12 and the reinforcement layer 14. The low density layer 16 can comprise a low density, polymer concrete mix that comprises a binder such as a thermoset resin and an aggregate that includes a low density filler material such as PET beads. The low density layer 16 reduces the overall weight of the cover 10. In one embodiment, the low density mix comprises, by weight, approximately 8.45% filler material, 58.28% sand, 20.90% ground silica, 0.37% carbon black power, 11.71% resin, 0.07% polymer initiator (tertiary-butyl peroxyneodecanoate), 0.18% organic peroxide, and 0.04% silane. It will be appreciated that this composition is exemplary, and the present disclosure encompasses a variety of compositions.

A second SMC layer 18 is positioned above the aforementioned layers 12, 14, 16. Having the low density layer 16 positioned between two SMC layers 12, 18 allow the cover to retain sufficient strength to pass rigorous testing standards. With this arrangement, the low density layer 16 occupies part of the volume of the cover 10 with a substantially reduced weight, and the SMC layers 12, 18 provide the necessary structure on either side of the low density layer 16 to resist load forces during testing. It will be appreciated that the first and second SMC layers 12, 18 may have the same composition or different compositions in various embodiments. Similarly, the second SMC layer 18 may incorporate a reinforcement layer such as metal rebar.

A top layer 20 serves as the upper surface of the cover 10. The top layer 20 can be comprised of a metal or abrasive resistant material that can withstand environmental conditions expected at the end use of the cover 10. For instance, a cover 10 that subject to vehicle traffic may have a robust top layer 20 such as asphalt, concrete, metal, etc. In various embodiments, the top layer 18 may be combined with the second SMC layer 18, and a fiber-reinforced resin layer serves as the top portion of the cover.

The proportions and the method of manufacturing the various layers 12, 14, 16, 18, 20 are critical to both achieving a substantial weight reduction and passing rigorous load and chemical exposure testing. For instance, in some embodiments, the first SMC layer 12 is between approximately 15-25% of the weight of the cover. In various embodiments, the first SMC layer 12 is approximately 18.4% of the weight of the cover. In some embodiments, the reinforcement layer 14 is between approximately 10-20% of the weight of the cover. In various embodiments, the reinforcement layer 14 is approximately 13.6% of the weight of the cover. In some embodiments, the low density layer 16 is between approximately 30-40% of the weight of the cover. In various embodiments, the low density layer 16 is approximately 35.5% of the weight of the cover. In addition, the low density layer 16 will comprise greater than 35.5% of the volume of the cover in various embodiments. In one embodiment, the lower density layer 16 is less than 40% of the weight of the cover but more than 40% of the volume of the cover.

In some embodiments, the second SMC layer 18 is between approximately 20-30% of the weight of the cover. In various embodiments, the second SMC layer 18 is approximately 24.1% of the weight of the cover. In some embodiments, the top layer 20 is between approximately 5-15% of the weight of the cover. In various embodiments, the top layer 20 is approximately 8.4% of the weight of the cover. Therefore, for a cover that weighs 90.9 lbs, the first SMC layer 12 is 16.7 lbs, the reinforcement layer 14 is 12.4 lbs, the low density layer 16 is 32.3 lbs, the second SMC layer 18 is 21.9 lbs, and the top layer 20 is 7.6 lbs. If too much of the cover were the low density layer, then the cover may not meet testing standards. Conversely, if too little of the cover were the low density layer, then the cover is reconfigured for only a marginal weight reduction. A weight reduction from a conventional cover can be between approximately 25-41%. Therefore, the arrangement of layers substantially reduces the weight of the cover, but allows the cover to meet testing standards.

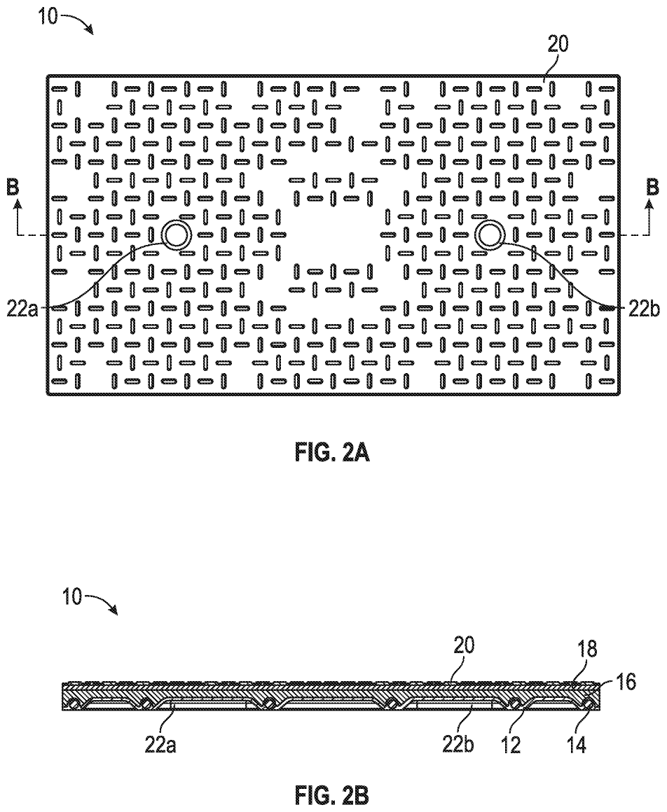

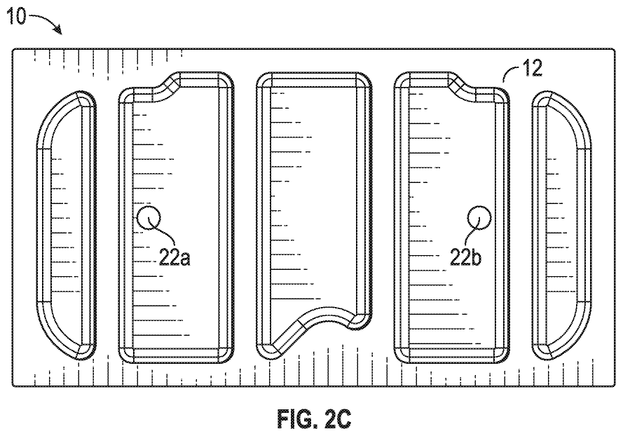

Now referring to FIGS. 2A-2C, various views of the cover 10 are provided. FIG. 2A is a top plan view of the cover 10 and the top layer 20. Two apertures 22a, 22b can extend through the cover 10 to provide, for example, drainage functionality for the cover 10. The top layer 20 can also have a textured pattern to provide added friction and traction for a vehicle or pedestrian. Line B-B is also provided in FIG. 2A, and FIG. 2B is a cross-sectional, elevation view of the cover 10 taken along line B-B. As shown in this view, the reinforcement layer 14 is embedded within the first SMC layer 12. FIG. 2C is a bottom plan view of the cover 10 and the first SMC layer 12.

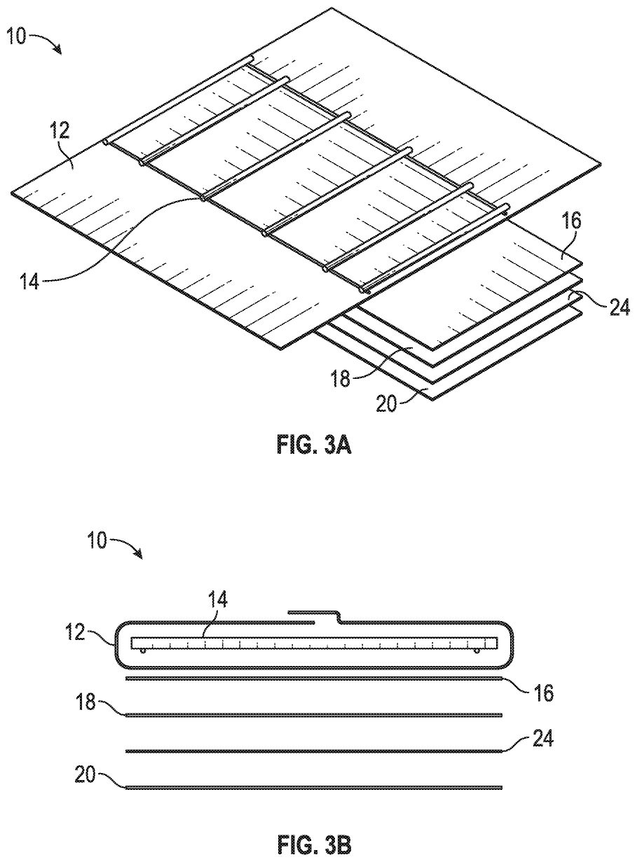

Now referring to FIGS. 3A and 3B, a perspective view and a side elevation view of a further cover 10 are provided, respectively. As shown, this cover 10 comprises a first SMC layer 12, a reinforcement layer 14, a low density layer 16, a second SMC layer 18, and a top layer 20. This cover 10 also comprises an additional layer 24, which can be a further SMC layer, a further low density layer, etc. It will be appreciated that embodiments of the present disclosure encompass embodiments beyond those depicted in FIGS. 1-3B.

### Low Density Filler Material

A low density filler material is used in combination with, for instance, a resin and catalyst to make a low density mix used to form a low density layer in a cover. A concrete material generally comprises a binder, resin and a catalyst in this embodiment, and one or more aggregates. Typically, the aggregates may comprise ¼″ gravel, silica sand, and silica flour. However, the gravel adds weight to the resulting cover. Therefore, at least some or all of the gravel is replaced with a low density filler material as described herein to reduce the weight of the cover. In some embodiments, the low density filler material is between approximately 5-20% of the weight of the low density mix.

The filler material can be a PET bead in some embodiments. For example, Armacell® manufactures a PET bead as described in U.S. Pat. No. 9,174,363, which is incorporated herein in its entirety by reference. PET beads can be manufactured in a batch process or a continuous process using environmentally friendly blowing agents. The PET bead can have an average cell size of between approximately 100-200 microns, without much variance in the average cell size from wall section to center of the bead. In some embodiments, the PET bead has an average cell size of between approximately 106-165 microns. The PET bead can have two or more layers where one layer is a cell wall with a thickness between approximately 6.0-8.5 microns. In some embodiments the cell wall thickness is between approximately 6.6-8.3 microns. In one embodiment, the PET bead has an average cell diameter of approximately 79.81 microns, a maximum cell diameter of approximately 431.81 microns, a minimum cell diameter of approximately 1.11 microns, and a standard deviation of approximately 65.25 microns. The PET beads or other beads described herein can be used to create a foam by chemical cross-linking and/or using electron beam methods. In addition, the beads may be free of residual gases, and bottle grade PET from either post-consumer or curbside collection sources may be used as raw materials in production.

The surface topography of a low density filler material such as a PET bead can have a substantially even distribution of pockets and ridges across the surface of the bead. In addition, the distance between a low point of a pocket to a high point of a ridge can be approximately 511 microns. In some embodiments, the low density filler material may be a foam bead that comprises a polyalkylene terephthalate resin in multiple layers. A first layer may have a thickness between approximately 30 and 120 microns, and a second layer with a thickness of less than approximately 100 microns. The second layer may have a cell diameter of less than approximately 15 microns and a third layer can have a cell diameter of less than approximately 400 microns. In some embodiments, the low density filler material can have a density of approximately 400 kg/m³. In various embodiments, the low density filler material can have a density of less than approximately 400 kg/m³.

While the low density filler material is described as a plurality of PET beads, several other materials can be used as a low density filler. For instance, below is a table of polyesters, which are a category of polymers that contain the ester functional group in their main chain, that can be used as a low density filler material. In addition, other low density filler materials can include an expanded glass such as Poraver® expanded glass with a diameter between 1-2 mm, a foam product such as Composite One® foam, an extruded polystyrene, a pumice, a scoria, a perlite, a vermiculite, a diatomite, a solid bead, a hollow bead, and a plastic.

TABLE 1
Polyesters.

| Main Chain | | Examples of | |
|---|---|---|---|
| Composition | Type | Polyesters | Manufacturing Methods |
| Aliphatic | Homopolymer | Polyglycolide or | Polycondensation of glycolic acid |
| | | polyglycolic acid (PGA) | |
| | | Polylactic acid (PLA) | Ring-opening polymerization of |
| | | | lactide |
| | | Polycaprolactone (PCL) | Ring-opening polymerization of |
| | | | caprolactone |
| | | Polyhydroxyalkanoate | |
| | | (PHA) | |
| | | Polyhydroxybutyrate | |
| | | (PHB) | |
| | Copolymer | Polyethylene adipate | |
| | | (PEA) | |
| | | Polybutylene succinate | Polycondensation of succinic acid |
| | | (PBS) | with 1,4-butanediol |
| | | Poly(3-hydroxybutyrate- | Copolymerization of 3- |
| | | co-3-hydroxyvalerate) | hydroxybutanoic acid and 3- |
| | | (PHBV) | hydroxypentanoic acid, |
| | | | butyrolactone, and valerolactone |
| | | | (oligomeric aluminoxane as a catalyst) |
| Semi- | Copolymer | Polyethylene | Polycondensation of terephthalic acid |
| aromatic | | terephthalate (PET) | with ethylene glycol |
| | | Polybutylene | Polycondensation of terephthalic acid |
| | | terephthalate (PBT) | with 1,4-butanediol |
| | | Polytrimethylene | Polycondensation of terephthalic acid |
| | | terephthalate (PTT) | with 1,3-propanediol |
| | | Polyethylene naphthalate | Polycondensation of at least one |
| | | (PEN) | naphthalene dicarboxylic acid with |
| | | | ethylene glycol |
| Aromatic | Copolymer | Vectran ® | Polycondensation of 4- |
| | | | hydroxybenzoic acid and 6- |
| | | | hydroxynaphthalene-2-carboxylic acid |

In various embodiments, the low density filler material can be a multi-layer bead or blend of beads comprising at least one of PGA, PLA, PCL, PHA, PHB, PEA, PBS, PHBV, PET, PBT, PTT, PEN, Vectran®, polycarbonates (PC), linear low density polyethylene (LLDPE), low density polyethylene (LDPE), polypropylene (PP), styrene acrylonitrile resin (SAN), styrene-ethylene-butylene-styrene (SEBS), polysulfone (PSU), polyether sulfones (PES), polyamide (PA), poly(p-phenylene ether) (PPE), liquid-crystal polymers (LCP), acrylic (PPMA), and acrylonitrile butadiene styrene (ABS). It will be appreciated that the above polymers are capable of being foamed on their own, or in the form of a blend in various combinations and concentration to render different desirable mechanical performance properties.

Other possible low density filler materials may include aliphatic-aromatic polyesters, such as polybutylene adipate terephtha late (PBAT), polybutylene sebacate terephthalate (PBSeT), polybutylene succinate terephthalate (PBST), polybutylene adipate tereph thalate (PBAT), and polybutylene sebacate terephthalate (PB SeT). In addition, lower temperature polyesters that can be effectively foamed with carbon dioxide (CO₂) may be used. These include the following polylactic acids from NatureWorks® and Ingeo®: 2002 D, 4032 D, 4042 D, and 4043 D, 8251 D, 3251 D, and 8051 D.

The low density filler material may comprise polymer and other blends that are possible to foam. These blends include polyamide (PA), blends, or copolymers such as PA/PP, PA/ABS, PET/ABS, PBT/ABS, PBT/PET/PC. In particular, it will be appreciated that PA includes many variations, such as PA-6 or 6/66. Additional low density filler materials include foams with up to 30% density reduction such as ABS, Acetal (POM), Polymethylmethacryalate (PMMA), Cellulose Acetate, Ethylene Vinyl Acetate (EVA), Nylon 6, Nylon 66, Polysulfone, Modified polyphenylene oxide (PPO), Polyarylether, Polyarylsulfone, Polycarbonate (PC), High-density polyethylene (HDPE), Polypropylene, Polybutylene terephthalate, Styrene acrylonitrile (SAN), and Polyvinyl Chloride (PVC).

A thermoset, such as melamine, phenol formaldehyde, polyurethane, and epoxy may also be used as a low density composite filler material. Lastly, the low density composite filler material may be a structural foam produced with chemical blowing agents or a solid-state foaming process.

### Method of Manufacturing

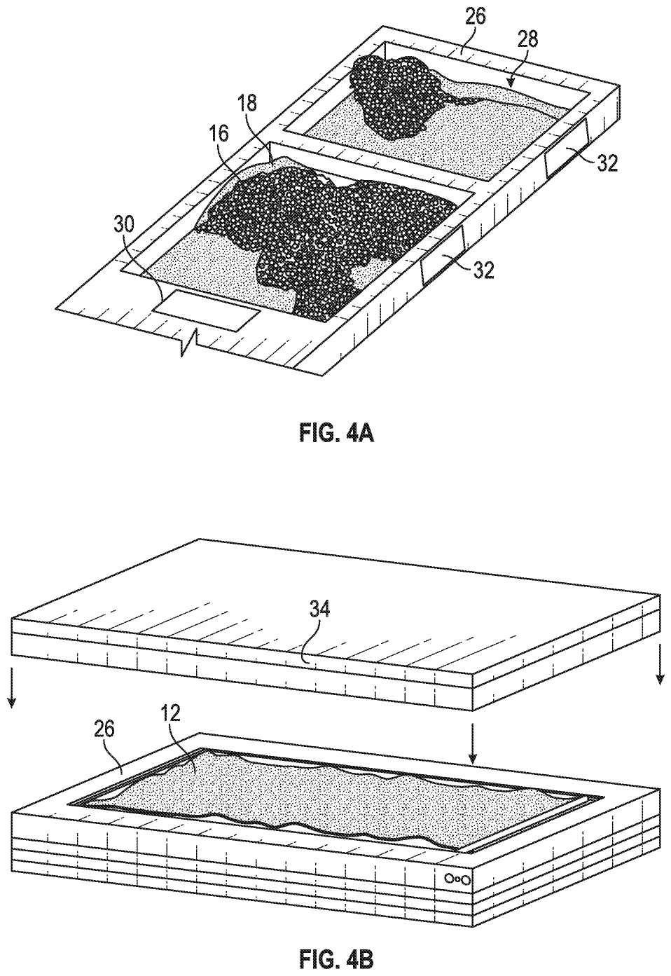

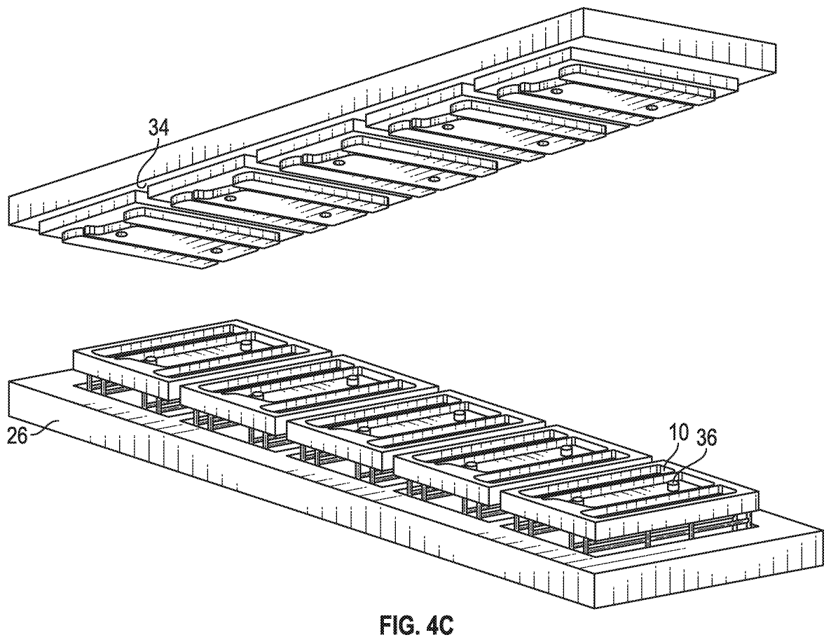

Now referring to FIGS. 4A-4C, various views of a form 26 and press 34 for manufacturing a composite concrete cover are provided. As shown in FIG. 4A, the form 26 defines one or more volumes 28 that receive the various layers of the cover. In this embodiment, the second SMC layer 18 is placed into the volume 28 of the form 26, and a low density mix that forms the low density layer 16 is poured on top of the second SMC layer 18. The form 26 can have one or more heaters 30 that set the temperature of the form 26 and combine and cure the layers of the cover as the cover is manufactured. The form 26 can also have one or more motors 32 that establish a vibration in the form 26 and remove air from interfaces between layers of the cover as the cover is manufactured.

In FIG. 4B, additional layers are positioned in the volume of the form 26 with the first SMC layer 12 shown. In addition, a top portion of a press 34 moves downwardly to engage and apply a force to the layers. FIG. 4C shows the press 34 removed from the layers of the cover 10, and a pair of cylinders 36 extending upward to eject the cover 10 from the form 26.

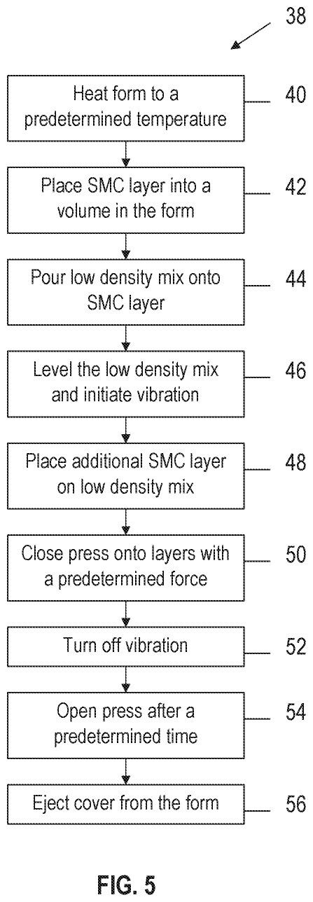

Now referring to FIG. 5, a method 38 for manufacturing a cover is provided. First, the form is heated 40 to a predetermined temperature by one or more heaters. In some embodiments, the predetermined temperature is between approximately 250-350° F. In various embodiments, the predetermined temperature is between approximately 0-350° F. Next, an SMC layer is placed 42 into a volume defined by the form. In this embodiment, the upper surface of the finished cover is placed into the form first, therefore, the SMC layer first placed into the form is the second SMC layer as described above with respect to FIGS. 1-3B.

Next, a low density concrete mix is poured 44 onto the SMC layer. The low density concrete mix in one embodiment comprises a combination of a thermoset resin and a dual catalyst such as an organic peroxide that serve as a binder. The thermoset resin can be manufactured by Reichhold®, Interplastics®, or AOC®, and the organic peroxide is a resin catalyst, which can be Luperox A75 manufactured by Luperox®. The low density concrete mix further comprises a combination of silica sand, silica flour, and a low density filler material that serve as an aggregate. Additional materials that can be used with the binder or aggregates include water, air, sand, aggregate, rock, gravel, fly ash, silica fume, slag, carbon black powder, and cement. The low density concrete mix cures with heat and will keep for over 24 hours after mixed. Buckets and hoppers can transfer the low density concrete mix from a standard concrete batch plant to the form used in the manufacturing process 38 in FIG. 5.

Then, the low density mix is leveled 46 by hand and/or a vibration induced by one or more motors of the form. The motors produce a mechanical wave at a frequency or range of frequencies to cause the layers of the cover to vibrate. This vibration agitates the layers including the various materials of the low density mix to cause air to leave the layers and the interfaces between layers. The removal of air produces a more thorough bonding of the layers with more polymer chains from each layer cross linked together.

A further SMC layer is positioned 48 on the low density concrete mix, and the press is closed 50 onto the layers with a predetermined force. In some embodiments, the predetermined force is between approximately 100-600 tons. In various embodiments, the predetermined force is between approximately 0-600 tons. The resulting pressure on the layers is between approximately 50-150 psi. In some embodiments, the pressure on the layers is approximately 100 psi. Once the force and pressure are applied to the layers, the motors are turned off 52 to stop the vibration.

The press applies force and pressure to the layers for a predetermined time, which in some embodiments is between approximately 7-10 minutes. Afterwards, the press is opened 54, and the cover is ejected 56 from the form, in some embodiments, by cylinders that extend into the volumes of the form. The cover can then be trimmed or otherwise finished and allowed to finish curing and cooling. Covers may cure as little as 15 minutes after being ejected from the form. It will also be appreciated that layers such as the top layer, reinforcement layer, and additional layer described above can be placed in the volume defined by the form so that these layers are incorporated into the finished cover.

Compression molding is described herein, and an example cover or product from this manufacturing method includes the Oldcastle® Plastibeton® product line of cable trough and covers. However, it will be appreciated that the disclosure provided herein can apply to other products and methods of manufacturing such as a trench or vault. One example of another manufacturing method is open molding, which is similar to compression molding but the layers are placed into a mold that is not heated. The layers, including the low density concrete mix, cure and harden while exposed to air. With open molding, fibers can be sprayed onto a resin to create an SMC layer. In addition, filament winding is an open molding process where fibers travel through a bath of resin before reaching a feature such as a mandrel or form that defines the shape of the finished product. The Oldcastle® polymer line of products can be manufactured using an open molding process.

Other types of manufacturing processes that can incorporate aspects of the present disclosure to produce a lightweight cover are drycasting and wetcasting. Typically, drycasting means that the concrete has a water-cement ratio of between approximately 0.30-0.36, and wetcasting means that this ratio is above approximately 0.40. These methods can be used to precast a layer of a cover or the entire cover. Low density filler materials can be utilized that occupy a percentage of the volume of the finished product while weighing less than at least some of the other materials used in the product. The Oldcastle® Christy® line of concrete enclosures can be manufactured using a drycast method, and the Oldcastle® precast line of products can be manufactured using a wetcast method.

### Testing Results

The disclosure and covers described herein not only result in a substantial weight savings, but the covers must also pass rigorous testing standards. The selection of materials, the proportions of the various layers of the cover, and/or the method of manufacturing the cover all contribute to the ability of the cover to pass rigorous testing standards. For example, a sample cover is subject to a vertical load test where a 20,800 lb load is applied for 10 seconds, the load is removed for 10 seconds, and then a rest period of 10 seconds elapses. This cycle is repeated 50 times, and the deflection of the cover is measured before and after the 50 cycles.

Additional tests for the cover include (i) ASTM D543-14 Practice A, Procedures 1 and 2 Modified—Evaluating the Resistance of Plastics to Chemical Reagents; (ii) ANSI/SCTE 77-2017 Section 6.1 & 6.2; (iii) ASTM G154 per Cycle #1 of Appendix X2 for 1000 hrs; (iv) ASTM D570-98 (2010) el Water Absorption; (v) ASTM D635-14 Flammability; and (vi) ASTM D790-17 Flexural Strength, which are incorporated herein in their entireties by reference. Regarding the chemical exposure testing, a sample cover is immersed in each of 5% sodium chloride, 0.1N sulfuric acid, 0.1N sodium carbonate, 0.1N sodium sulfate, 0.2N hydrochloric acid, 0.1N sodium hydroxide, 5% acetic acid, kerosene, transformer oil, and 5% magnesium chloride for 7 days. The total weight of the cover must not change more than 2%.

For the sunlight exposure test, a sample cover is exposed to simulated sunlight for 1000 hours, and the total weight of the cover must not change more than 2%. For the water absorption test, a sample cover is immersed in water for 24 hours and another sample cover is immersed in boiling water for 2 hours, and the total weight of the cover must not change more than 2%. For a flexural test, the sample covers from the previous tests must retain a flexural strength of at least 1497.6 psi. For a flammability test, the burning rate of a sample cover must be less than 0.3 inches per minute for every 0.1 inch of thickness. A cover made with the materials, proportions, and methods encompassed by the disclosure herein passed all of these tests.

The description of the present disclosure has been presented for purposes of illustration and description but is not intended to be exhaustive or limiting of the disclosure to the form disclosed. Many modifications and variations will be apparent to those of ordinary skill in the art. The embodiments described and shown in the figures were chosen and described in order to best explain the principles of the disclosure, the practical application, and to enable those of ordinary skill in the art to understand the disclosure.

While various embodiments of the present disclosure have been described in detail, it is apparent that modifications and alterations of those embodiments will occur to those skilled in the art. Moreover, references made herein to “the present disclosure” or aspects thereof should be understood to mean certain embodiments of the present disclosure and should not necessarily be construed as limiting all embodiments to a particular description. It is to be expressly understood that such modifications and alterations are within the scope and spirit of the present disclosure, as set forth in the following claims.

What is claimed is:

1. A method of manufacturing a low density composite concrete material, comprising:
mixing a thermoset resin, a catalyst, and at least one aggregate to form a polymer concrete mix, wherein said at least one aggregate has a filler material with a density less than 400 kg/m³;
heating a form to at least 200° F., wherein said form has a predetermined shape and defines a volume;
positioning a first polymer concrete layer in said form;
pouring said polymer concrete mix on said first polymer concrete layer;
positioning a second polymer concrete layer on said polymer concrete mix;
vibrating said form to remove at least some air at a first interface between said first polymer concrete layer and said polymer concrete mix and at a second interface between said polymer concrete mix and said second polymer concrete layer; and
pressing said first polymer concrete layer, said polymer concrete mix, and said second polymer concrete layer into said form with at least 80 psi of pressure to form a composite concrete material.

2. The method of claim 1, further comprising driving a cylinder into said volume defined by said form to release said composite concrete material from said form.

3. The method of claim 2, wherein said first polymer concrete layer, said polymer concrete mix, and said second polymer concrete layer are pressed for at least six minutes before driving said cylinder into said volume defined by said form.

4. The method of claim 1, wherein said polymer concrete mix has a lower density than said first polymer concrete layer, and said polymer mix weighs more than said first polymer concrete layer.

5. The method of claim 1, wherein at least one electric heater heats said form to between approximately 250-350° F.

6. The method of claim 1, wherein said composite concrete material is at least one of a vault cover, a trench enclosure, or a utility vault.

7. A composite concrete cover, comprising:
a first concrete layer that has a first polymer and a plurality of reinforcing fibers;
a second concrete layer that has a second polymer and said plurality of reinforcing fibers;
a low density layer positioned between said first concrete layer and said second concrete layer, wherein said low density layer has a third polymer and has a filler material with a density of less than 400 kg/m³, and wherein said low density layer is less than 40% of a weight of said composite concrete cover and greater than 40% of a volume of said composite concrete cover;
a first interface between said first concrete layer and said low density layer, wherein at least one polymer chain of said first polymer and at least one polymer chain of said third polymer are cross linked together; and
a second interface between said second concrete layer and said low density layer, wherein at least one polymer chain of said second polymer and at least one polymer chain of said third polymer are cross linked together.

8. The composite concrete cover of claim 7, further comprising a reinforcement layer embedded in said first concrete layer, wherein said reinforcement layer has higher tensile strength and ductility than said first concrete layer.

9. The composite concrete cover of claim 7, wherein said first polymer is a thermoset polymer, and said plurality of reinforcing fibers of said first concrete layer are fiberglass.

10. The composite concrete cover of claim 7, wherein said third polymer is a thermoset polymer, and said low density layer comprises an organic oxide, silica sand, and silica flour.

11. The composite concrete cover of claim 7, further comprising at least one aperture extending through said first concrete layer, said low density layer, and said second concrete layer.

12. The composite concrete cover of claim 7, further comprising:
a top layer positioned on said second concrete layer, wherein said top layer is at least partially formed of a fourth polymer; and
a third interface between said top layer and said second concrete layer, wherein at least one polymer chain of said second polymer and at least one polymer chain of said fourth polymer are cross linked together.

13. The composite concrete cover of claim 12, wherein said top layer has a plurality of protrusions extending from an outer surface of said top layer to improve traction.

14. A method of manufacturing a low density composite concrete cover, comprising:
mixing a polymer and at least one aggregate to form a polymer concrete mix, wherein said at least one aggregate has a filler material with a density less than 400 kg/m³;
heating a form to at least 200° F., wherein said form has a predetermined shape and defines a volume;
positioning a first concrete layer in said form, said first concrete layer having a first polymer and reinforcement fibers;
pouring said polymer concrete mix on said first concrete layer, wherein a first interface is defined between said first concrete layer and said polymer concrete mix;
positioning a second concrete layer on said polymer concrete mix, said second concrete layer having a second polymer and reinforcement fibers, wherein a second interface is defined between said second concrete layer and said polymer concrete mix; and
pressing said first concrete layer, said polymer concrete mix, and said second concrete layer into said form with at least 80 psi of pressure for at least 6 minutes, wherein at least one polymer chain of said polymer concrete mix and said first polymer are cross linked at said first interface, and wherein at least one polymer chain of said polymer concrete mix and said second polymer are cross linked at said second interface.

15. The method of claim 14, further comprising vibrating said form to remove at least some air at said first interface and at said second interface.

16. The method of claim 15, wherein vibrating said form begins as said polymer concrete mix is poured onto said first concrete layer and stops as said first concrete layer, said polymer concrete layer, and said second concrete layer are pressed together.

17. The method of claim 15, further comprising:
embedding a reinforcement layer in said second concrete layer, wherein said reinforcement layer has a higher tensile strength and ductility than said second concrete layer.

18. The method of claim 15, wherein said filler material is one of a plurality of polyethylene terephthalate foam beads or a plurality of expanded glass beads.

19. The method of claim 15, wherein said first concrete layer, said polymer concrete mix, and said second concrete layer are pressed into said form for between approximately 7-10 minutes.

20. The method of claim 15, wherein a hydraulic press presses said first concrete layer, said polymer concrete mix, and said second concrete layer into said form with a pressure between approximately 80 and 150 psi.
